(19) United States
(12) Patent Application Publication
(10) Pub. No.: US 2005/0077734 A1
(43) Pub. Date: Apr. 14, 2005

(54) Truck lid latch assembly of a vehicle

(76) Inventor: Nam Hyeok Lim, Whasungsi (KR)

Correspondence Address: MORGAN, LEWIS & BOCKIUS LLP (SF), 2 PALO ALTO SQUARE, PALO ALTO, CA, 94306, US

(21) Appl. No.: 10/885,179

(22) Filed: Jul. 6, 2004

(30) Foreign Application Priority Data
Oct. 14, 2003 (KR) 10-2003-0071511

(51) Int. Cl. E05C 3/06

(52) U.S. Cl. 292/216

(57) ABSTRACT

A trunk lid latch assembly provides an emergency release of a locked trunk from within. Therefore, if a person becomes trapped within the trunk, the trunk can be unlocked from within and the person can escape. The trunk lid latch assembly also provides operation of a trunk lamp for illuminating the inside of the trunk space.

### CROSS REFERENCE TO RELATED APPLICATIONS

This application claims priority of Korean Application No. 10-2003-0071511, filed Oct. 14, 2003, the disclosure of which is incorporated herein by reference.

### TECHNICAL FIELD OF THE INVENTION

The present invention relates to a trunk lid latch assembly of a vehicle. More specifically the latch assembly provides a compact emergency escape lever to open a trunk lid of the vehicle and also functions to operate a room lamp of the trunk.

### BACKGROUND OF THE INVENTION

Typically, a trunk lid can be switched between a locked and an unlocked state while it is closed or open. Also, if the trunk lid is open, the trunk room lamp is often turned on to illuminate the interior of the trunk room. In the case where a person becomes accidentally confined within the trunk room that person should be able to unlock the trunk lid from inside to escape from within, however, the traditional trunk does not provide this capability.

### SUMMARY OF THE INVENTION

According to preferred embodiments, the present invention provides a compact trunk lid latch assembly. The latch can unlock the trunk lid and be operated by a person positioned within the trunk. The switch also operates the trunk lamp to illuminate the trunk with light. In one preferred embodiment, the present invention combines previously separate functions of key opening, emergency opening, and light switch, as well as remote opening and valet lockout in one assembly.

Preferably, the trunk lid latch assembly includes a fork lever installed on a base plate that can be rotated and change the latch from a locked position to an unlocked position by rotation of the lock with respect to a striker. A pole lever is installed on the base plate and can be rotated and restrict rotation of the fork lever. A tension coil spring is preferably installed between the pole lever and the fork lever to provide tension and a release lever is installed to allow the release of the restricted rotation of the fork lever by rotating the pole lever. A key release rod joined with the release lever that can rotate the release lever through power provided by the key operation. An electric actuator is provided and an actuator lever is installed to allow the pole lever to release restriction on the rotation of the fork lever by operation of the electric actuator. An emergency release knob is revealed to the interior of the trunk room and an emergency lever is connected with the emergency release knob and installed to rotate the release lever.

### BRIEF EXPLANATION OF THE DRAWINGS

For better understanding of the nature and objects of the invention, reference should be made to the following detailed description, taken in conjunction with the accompanying drawings, in which:

FIG. 1 is a schematic view of a trunk lid latch assembly of a vehicle according to an embodiment of the present invention;

FIG. 2 is illustrates a locked state of a trunk lid latch assembly of a vehicle according to an embodiment of the present invention;

FIG. 3 is illustrates a state of operation of an emergency escape knob according to an embodiment of the present invention;

FIG. 4 is shows a view from an opposite side of FIG. 2 to explain a room lamp switch according to an embodiment of the present invention;

FIG. 5 is illustrates a state that an insulator is removed from the state of FIG. 4 and a state that the trunk lid is closed according to an embodiment of the present invention;

FIG. 6 illustrates a state that a trunk lid is opened in comparison with a state shown in FIG. 5 according to an embodiment of the present invention; and

FIG. 7 illustrates a state in comparison with a state shown in FIG. 2 according to an embodiment of the present invention.

### DETAILED DESCRIPTION OF PREFERRED EMBODIMENTS

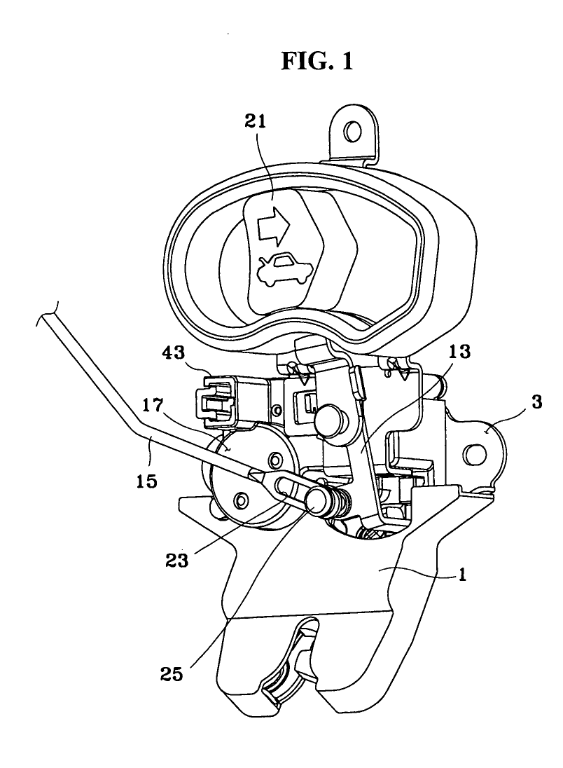

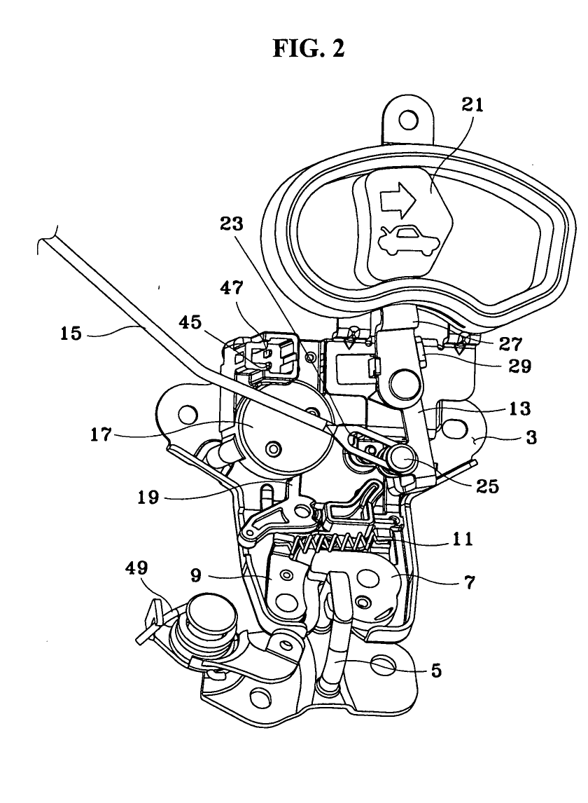

According to FIGS. 1 and 2 a trunk lid latch assembly of a vehicle is equipped with a base plate (3) joined with a trunk lid. A fork lever (7) is installed on the base plate (3) and rotatable with respect to a striker (5) such that the latch is locked or unlocked from the striker 5. A pole lever (9) is installed on the base plate (3). The pole lever (9) is rotatable and can restrict rotation of the fork lever (7). A tension coil spring (11) is installed to give tension between the pole lever (9) and fork lever (7). Therefore, the pole lever (9) and fork lever (7) are caused to rotate together through the pull of the tension coil spring (11). FIG. 2 illustrates a state that rotation of fork lever (7) is restricted by the pole lever (9).

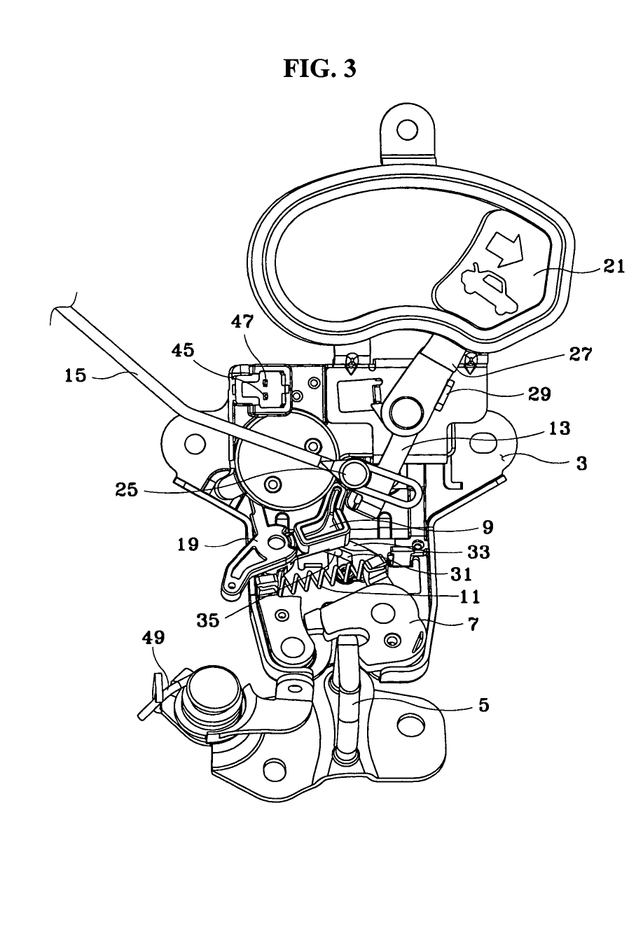

According to FIG. 3, if the pole lever (9) is rotated the fork lever (7) will be able to rotate and at this time. The tension coil spring (11) provides the power to rotate the fork lever (7) in the counter-clockwise and release it from the striker (5). If the fork lever (7) is rotated in the clockwise direction by the striker (5) when the trunk lid is closed, the pole lever (9) is also rotated in the clockwise direction, toward the fork lever (7), by the tension coil spring (11) and thus rotation of the fork lever (7) is restricted.

The trunk lid latch assembly is also preferably equipped with a release lever (13) installed in such a way that the restricted rotation of the fork lever (7) can be released by rotating the pole lever (9). A key release rod (15) is joined with the release lever (13) and can rotate the release lever (13) by the power provided through operation of a key. An electric actuator (17) is provided and an actuator lever (19) is installed to allow the pole lever (9) to release restriction of rotation of the fork lever (7) by operation of the electric actuator (17).

The release lever (13) is fastened in such a state that it can rotate to the base plate (3) and rotate the pole lever (9) in the clockwise direction as it rotates in the clockwise direction. The release lever (13) is connected to the key release rod (15) which can rotate the release lever (13) in the clockwise direction by a pulling force from a user that rotates a key cylinder.

The key release rod (15) is joined with the release lever (13) by placement of a pin (25) through long hole (23). The long hole (23) helps the release lever (13) can accommodate the movement without being influenced in its rotational movement by movement of the electric actuator (17) or emergency release knob (21).

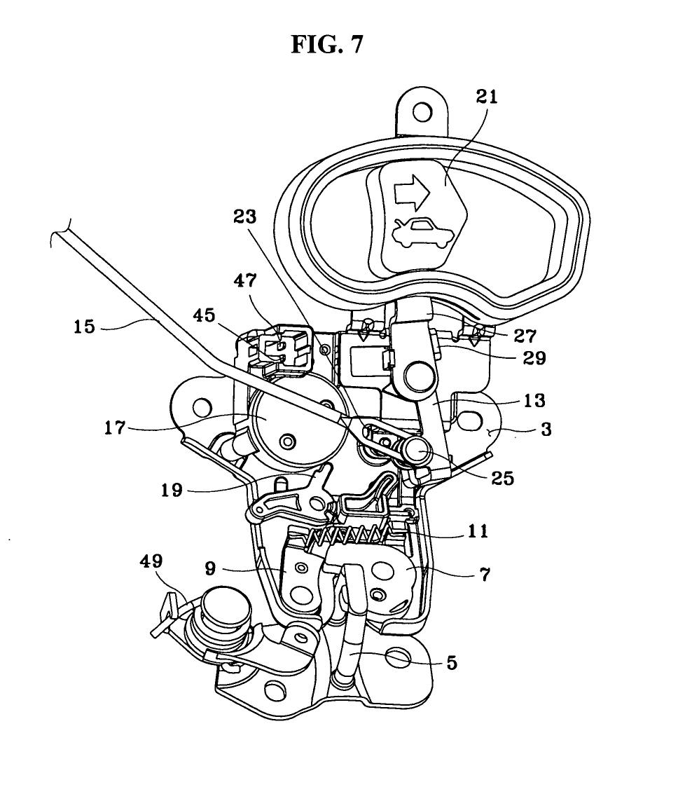

The electric actuator (17) is designed to be able to rotate the actuator lever (19) in the clockwise direction and also rotate the pole lever (9) by an internal motor. Where the actuator lever (19) is locked into the pole lever (9) in such a way that rotation is possible so that it is switched to a state shown in FIGS. 2 and 7. In other words, the actuator lever (19) is mounted in such a way that it can rotate to the pole lever (9) and will be switched between a state that it can rotate the pole lever (9) by receiving operating power from the electric actuator (17), as shown in FIG. 2, and the state that it can't rotate the pole lever (9) by not receiving the operating power from the electric actuator (17), as shown in FIG. 7. Therefore, when the actuator lever (19) is positioned as illustrated in FIG. 2, if an electric switch operated at a driver's seat is operated, the electric actuator (17) is driven and the pole lever (9) will be able to be rotated through the actuator lever (19). However, when the actuator lever (19) is positioned as illustrated in FIG. 7, even if the electric actuator (17) is driven by operation of the electric switch at the driver's seat, the electric actuator (17) can not rotate the actuator lever (19) and thus the pole lever (9) won't be rotated.

According to an alternative embodiment, the actuator lever (19) is not rotated by the electric actuator (17). A user can chose this feature by rotating the actuator lever (19) to the pole lever (9). Thereby, operation of the electric switch to unlock the trunk is prevented such that a user can not open the trunk from operation of a switch near the driver's seat. Therefore, items can be stored and secured in the trunk from an individual having access to the switch near the driver's seat.

Preferably, an emergency lever (27) is connected to an emergency release knob (21). The emergency lever (27) is installed in such a way that it can rotate the release lever (13). The emergency release knob (21) that is revealed in the interior of the trunk room is provided on the end of the emergency lever (27) such that it is accessible to one locked within the trunk. The emergency lever (27) is designed and installed to have the same rotation axis as the release lever (13). The release lever (13) is provided with the hooking lug (29) which allows the emergency lever (27) to rotate in only one direction toward the release lever (13). Namely, when the key release rod (15) is operated, the release lever (13) prevents the emergency lever (27) from moving. However, if the emergency lever (27) is rotated, the release lever (13) is rotated. Of course, when the release lever (13) is rotated by rotation of the emergency lever (27), the key release rod (15) will not move due to the long hole (23) and pin (25).

According to another embodiment of the present invention, a room lamp switch is also provided in the truck lid latch assembly. The room lamp switch can switch the room lamp on or off by changing a state of grounding of the car body through the base plate (3). This grounding can be generated by rotation of the pole lever (9).

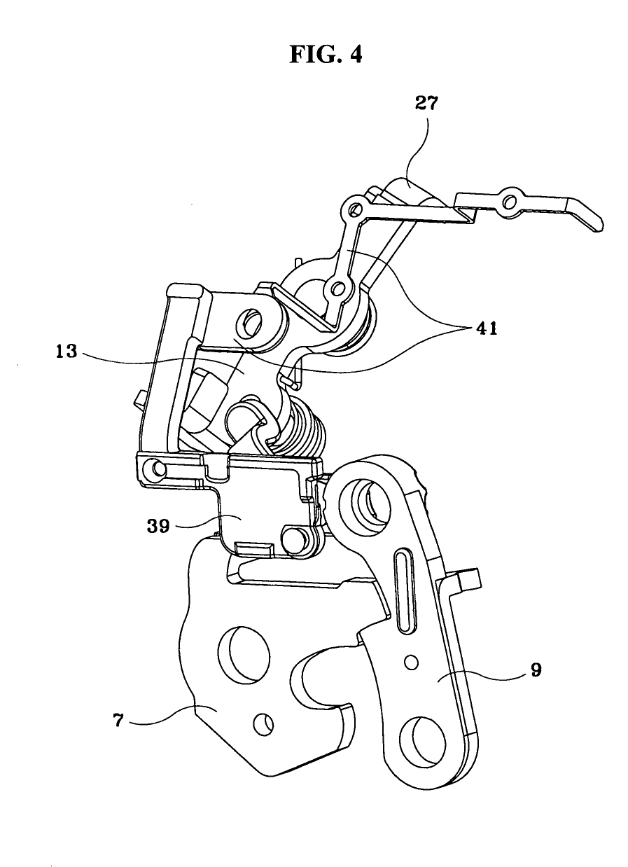

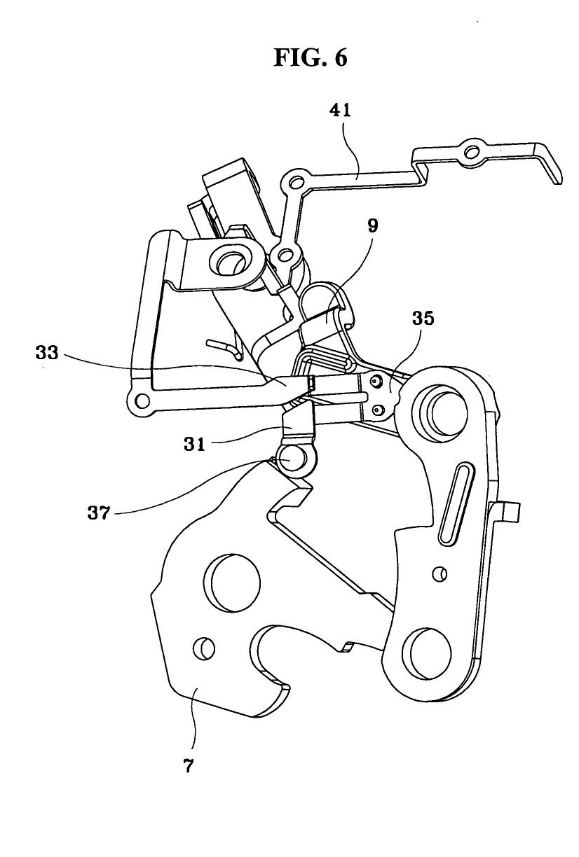

As illustrated in FIGS. 4-6, the room lamp switch is composed of a first electrode plate (31) installed to have the state of electric connection with the base plate (3). A second electrode plate (33) is installed to have the state of electric insulation to the base plate (3). A switch plate (35) is integrated into the pole lever (9) to change the electric connection state of the first electrode plate (31) and second electrode plate (33) according to a rotated state of the pole lever (9). Namely, the base plate (3) is grounded to the car body through the trunk lid, the first electrode plate (31) has the state of electric connection with the base plate (3) by the rivet (37), the second electrode plate (33) is installed to have electric insulation to the base plate (3) by the insulator (39), and the switch plate (35), which changes the connection state of the first electrode plate (31) and second electrode plate (33), is integrated into the pole lever (9).

A copper plate (41) is connected from the second electrode plate (33) and is connected with the lower terminal (45) of the connector (43) in an insulated state. The lower terminal (45) is connected with one terminal of the room lamp through a wire and the other terminal of the room lamp is connected with the plus electrode of the battery. It is preferably that the remaining upper terminal (47) of the connector (43) is to drive the electric actuator (17).

In use, if the trunk is closed, as illustrated in FIG. 3, the fork lever (7) is rotated clockwise from power provided when it is engaged with the striker (5) and is locked into the striker (5). This state is continuously maintained as the pole lever (9) is pulled toward the fork lever (7) and rotated by the power of the tension coil spring (11). Thus the locked state of the trunk lid is maintained.

In the locked state, as illustrated in FIG. 2, if the driver, at the driver's seat, rotates the actuator lever (19) in the counter-clockwise direction with aid of the electric actuator (17) by operating the electric switch, the pole lever (9) is also rotated and the fork lever (7) is becoming able to rotate in the counter-clockwise direction. The elastic power provided by the tension coil spring (11) at this time allows the fork lever (7) to rotate in the counter-clockwise direction, thereby releasing lock with the striker (5). Of course, if the locked state between the fork lever (7) and the striker (5) is released as describe above, the trunk lid receives the pressure to be opened by the torsion spring (49) on the side of the striker (5) illustrated on the lower part of FIGS. 2-3.

If the user pulls the key release rod (15) using the key, the release lever (13) is rotated clockwise from the state illustrated in FIG. 2 to the state illustrated in FIG. 3, thereby causing the pole lever (9) to be rotated and enabling the fork lever (7) to be able to release the state of being locked with the striker (5).

If the locked state, as illustrated in FIG. 2, accidentally takes place with someone in the trunk room, the person in the trunk room can release the locked state of the trunk lid by rotating the emergency release knob (21), as illustrated in FIG. 3. Namely, if the emergency release knob (21) is rotated clockwise from the state illustrated in FIG. 2 to the state illustrated in FIG. 3, the emergency lever (27) provides rotating power to the hooking lug (29) of the release lever (13) and the release lever (13) thereby rotates clockwise and the pole lever (9) rotates the fork lever (7) to release the striker (5) and unlock the trunk.

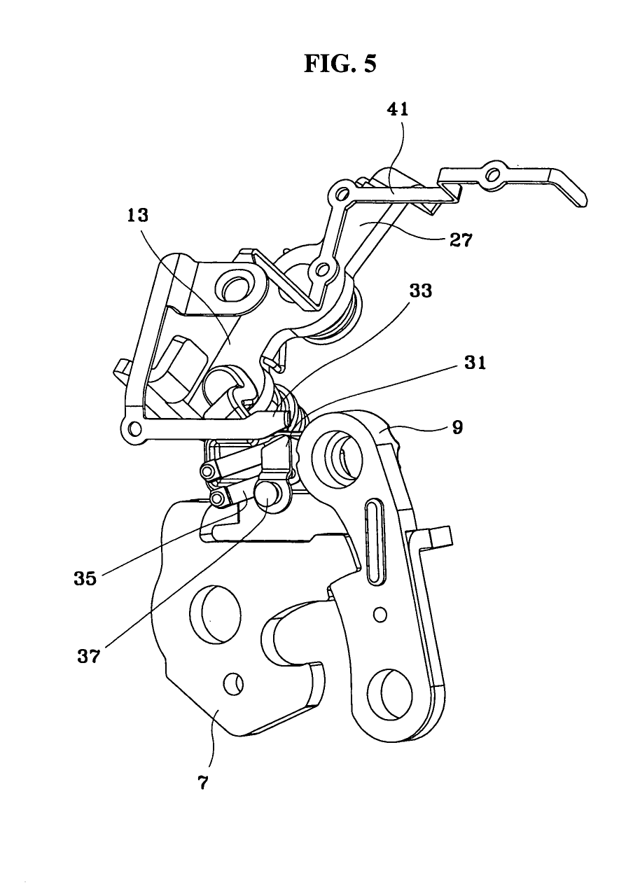

The operation of the room lamp switch will now be detailed. FIG. 4 shows a view from an opposite side of FIG. 2 and illustrates the insulator (39) for insulating the second electrode plate (33). FIG. 5 shows a view of the state illustrated in FIG. 4 with the insulator (39) removed and the trunk closed. When the trunk lid is closed like this, the switch plate (35) integrated into the pole lever (9) contacts only the first electrode plate (31) so the room lamp is not turned on as it is not grounded. FIG. 5 shows the released state of the locked trunk lid. As the fork lever (7) is rotated by rotation of the pole lever (9), the switch plate (35) is also move together by rotation of the pole lever (9) and both of the first electrode plate (31) and second electrode plate (33) comes into contact with the switch plate (35). Therefore, the room lamp is turned on as it is grounded by the second electrode plate (33), its switch plate (35), and the first electrode plate (31). As a result, when locking and releasing the latch assembly, the room lamp is automatically turned on and off by the movement of the pole lever (9) without any separately installed switch.

As describe above, the present invention reduces cost of vehicle manufacturing processes and performs the functions of not only locking and unlocking a trunk lid of a car body but also the room lamp switch that moves together with the pole lever. Furthermore, the release lever and emergency release knob make it possible to escape from the trunk in an emergency if accidentally locked in the trunk room.

1. A trunk lid latch assembly of a vehicle, comprising:
a fork lever rotatably installed on a base plate for cooperation with a strike in a locked state;
a pole lever rotatably installed on the base plate and configured to restrict rotation of the fork lever;
a tension spring installed between the pole lever and the fork lever to bias said levers;
a release lever installed to allow release of restricted rotation of the fork lever by rotating the pole lever;
a key release rod joined with the release lever, the key release rod capable of rotating the release lever by power provided by operation of a key;
an electric actuator;
an actuator lever installed to allow the pole lever to release restriction on rotation of the fork lever by operation of the electric actuator;
an emergency release knob configured and positioned to be accessible on an interior of the trunk; and
an emergency lever cooperating with the emergency release knob to rotate the release lever.

2. The trunk lid latch assembly of claim 1, wherein the key release rod is joined with the release lever by a pin at a long hole such that the release lever can accommodate movement without being influenced in its rotation movement by movement of the electric actuator or emergency release knob.

3. The trunk lid latch assembly of claim 1, wherein the actuator lever is mounted such that it can rotate to the pole lever to be switched between a state wherein it rotates the pole lever by receiving operating power from the electric actuator and a state wherein it does not rotate the pole lever by not receiving operating power from the electric actuator.

4. The trunk lid latch assembly of claim 1, wherein the emergency lever is configured and dimensioned to have a rotation axis the same as the release lever and the release lever is provided with a hooking lug which allows the emergency lever to rotate in only one direction.

5. A trunk lid latch assembly of a vehicle, comprising:
a fork lever installed on a base plate, wherein the fork lever is to be rotated and thereby change a state of locking into a striker;
a pole lever installed on the base plate that can be rotated and restrict rotation of the fork lever;
a tension coil spring installed between the pole lever and the fork lever to give tension therebetween;
a release lever installed to allow release of restricted rotation of the fork lever by rotating the pole lever;
a key release rod joined with the release lever that can rotate the release lever by power provided through operation of a key;
an electric actuator;
an actuator lever installed to allow the pole lever to release restriction on rotation of the fork lever by operation of the electric actuator;
an emergency release knob revealed to an interior of the trunk room;
an emergency lever connected with the emergency release knob and installed to rotate the release lever; and
a room lamp switch that can turn a room lamp on or off by changing a state of grounding with a car body through the base plate according to a state of rotation of the pole lever.

6. The trunk lid latch assembly of claim 5, wherein the key release rod is joined with the release lever by a pin such that its part to be joined with the release lever is formed as a long hole so that the release lever can accommodate movement without being influenced in its rotation movement by movement of the electric actuator or emergency release knob.

7. The trunk lid latch assembly of claim 5, wherein the actuator lever is mounted in such a way that it can rotate to the pole lever and will be switched between a state that it can rotate the pole lever by receiving an operating power from the electric actuator and a state that it can not rotate the pole lever by not receiving operating power from the electric actuator.

8. The trunk lid latch assembly of claim 5, wherein the emergency lever is designed and installed to have a rotation axis similar to a rotation axis of the release lever and the release lever is provided with a hooking lug which allows the emergency lever to rotate in only one direction to the release lever.

9. The trunk lid latch assembly of claim 5, wherein the room lamp switch comprises:
a first electrode plate installed to have a state of electric connection with the base plate;
a second electrode plate installed to have a state of electric insulation to the base plate; and
a switch plate integrated into the pole lever to change an electric connection state of the first electrode plate and second electrode plate according to the rotation state of the pole lever.
